(19) United States
(12) Patent Application Publication
(10) Pub. No.: US 2015/0162956 A1
(43) Pub. Date: Jun. 11, 2015

(54) NEAR FIELD COMMUNICATION BASED DATA TRANSFER

(71) Applicant: Raveeshkumar Bhat, Bangalore (IN)

(72) Inventor: Raveeshkumar Bhat, Bangalore (IN)

(21) Appl. No.: 14/098,572

(22) Filed: Dec. 6, 2013

(51) Int. Cl. H04B 5/00; G06Q 40/00; G06Q 10/10

(52) U.S. Cl. CPC H04B 5/0031; G06Q 10/105; G06Q 40/12

(57) ABSTRACT

Various embodiments of systems and methods for near field communication based data transfer are described herein. Initially an NFC tag receives dynamic data from a data management system. Next the NFC tag forwards the received dynamic data to a portable electronic device. Based on the forwarded dynamic data, the NFC tag receives data update from the portable electronic device. Finally, the NFC tag updates the data management system with the data update.

### BACKGROUND

Workforce management encompasses different employee services that assist in maintaining a productive workforce. Employee services may include: employee leave request services, employee self-services, employee performance management services, etc. Currently, work force management related services are provided by a central server that stores the employee data, such as, number of leaves remaining for an employee, number of hours spent on a particular project, etc.

An employee can accesses these services by logging to the company's network and then accessing the central server providing these services. In a typical work day, a user may be using several of these services, for example, applying for a leave, supplying time spent on a particular project, checking salary information, etc. Logging to the company's network each time the user wants to access any of these services may be cumbersome and time-consuming for the employee.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a flow diagram illustrating a process for near field communication (NFC) based data transfer, according to an embodiment.

FIGS. 2A-2B are flow diagrams illustrating an algorithm for a “data transfer” method written to a NFC tag, according to an embodiment.

FIG. 3 is a sequence diagram illustrating a method for transferring data by a NFC tag, according to an embodiment.

FIG. 4 is an exemplary user interface of a portable electronic device displaying a graphical user interface of an employee leave request application, according to an embodiment.

FIG. 5 is an exemplary user interface of a portable electronic device displaying a success message, according to an embodiment.

FIG. 6 is a block diagram illustrating a computing environment of near field communication based data transfer, according to an embodiment.

### DETAILED DESCRIPTION

Embodiments of techniques for near field communication based data transfer are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment. Thus, the appearances of these phrases in various places throughout this specification are not necessarily all referring to the same embodiment. Furthermore, the particular features, structures, or characteristics may be combined in any suitable manner in one or more embodiments.

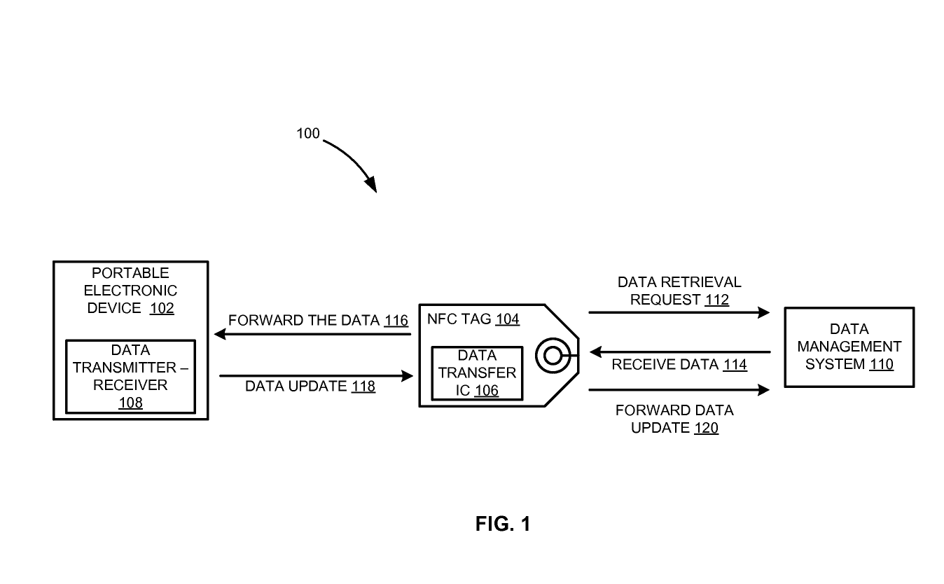

FIG. 1 is a block diagram illustrating a process 100 for near field communication based data transfer, according to an embodiment. Near field communication (NFC) is a set of standards to establish radio communication between two devices which are in direct contact or within a predetermined range, for example, 10 centimeters, from each other. In one embodiment, the near field communication is established between portable electronic device 102 and NFC tag 104. The NFC tag 104 is a passive device, for example, a sticker or a wristband, which includes “data transfer” integrated circuit (IC) 106. The “data transfer” IC 106 of the NFC tag 104 controls data transfer by the NFC tag 104. The portable electronic device 102 may be a handheld or wearable electronic device, for example, mobile phone, tablet computer, laptop, personal digital assistant, etc. In one embodiment, the portable electronic device 102 is a NFC enabled portable electronic device that may establish NFC communication with the NFC tag 104. The portable electronic device 102 may include data transmitter-receiver module 108 for writing data to the NFC tag 104 and receiving data from the NFC tag 104.

In one embodiment, the NFC tag 104 may be programmed to facilitate data transfer between the portable electronic device 102 and data management system 110. The data management system 110 may be a data server that stores and processes data. In one embodiment, the data management system 110 may be provided in a cloud. Cloud computing addresses a variety of computing concepts that involve a large number of computers connected through a real-time communication network such as the Internet. In one embodiment, programming the NFC tag 104 may include writing a “data transfer” program to the “data transfer” IC 106 of the NFC tag 104. The “data transfer” program defines a sequence of data transfer steps for two-way communication between the portable electronic device 102 and the NFC tag 104.

For example, the data transfer steps in the “data transfer” program may include: initially sending data retrieval request 112 to the data management system 110. Next, the NFC tag 104 may receive 114 data from the data management system 110, in response to the data retrieval request. Next, the NFC tag 104 forwards 116 the received data to the portable electronic device 102. Based on the received data, the portable electronic device 102 may send 118 data update to the NFC tag 104. The NFC tag 104 may finally forward 120 the received data update to the data management system 110.

In one embodiment, several applications may use the “data transfer” program, written to the “data transfer” IC 106 of the NFC tag 104. The applications may use the “data transfer” program to perform application data transfer between the portable electronic device 102 and the data management system 110, at runtime. An application or an “app” is computer software that when executed performs a useful task. In one embodiment, the applications may also be written to the “data transfer” IC 106 included in the NFC tag 104. The applications may be included in the “data transfer” program written to the “data transfer” IC 106 of the NFC tag 104. Alternatively, the application may be a stand-alone application written to the “data transfer” IC 106 of the NFC tag 104.

In one embodiment, the NFC tag 104 allows a user of the portable electronic device 102 to access and update application data to the data management system 110, without requiring the user of the portable electronic device 102 to login to the data management system 110. Specifically, the data transfer steps included in the “data transfer” program written to the NFC tag 104 allows application data transfer between the portable electronic device 102 and the data management system 110, without requiring the user to login to the data management system 110.

For example, consider a “time recording” application that is used for recording time spent by an employee on a particular project. In this case the “data transfer” program, included in the NFC tag, may facilitate data transfer between an NFC enabled portable electronic device of the employee and an employee data management system that manages employee information, including time spent by the employee on a particular project. The data transfer steps defined by the “data transfer” program may be used for transferring “time recording” application data between the employee data management system and the portable electronic device. Based on the “data transfer” program, initially the NFC tag may send a “data retrieval” request for receiving “time recording” data, for example, names of the projects on which the employee is currently working, name of the employee, and the “time spent” information that includes information of the time spent by the employee on the different projects. Based on the “data retrieval” request, the NFC tag receives the “time recording” data that includes, e.g., project names “Alpha” and “Beta”, name of the employee “IJKL”, and the time spent as “3 days” and “1 day” for projects “Alpha” and “Beta”, respectively, from the data management system. Next, the NFC tag forwards the “time recording” data to the portable electronic device. The employee may then update the “time recording” data for project “Beta” from “1 day” to “2 days”, at the portable electronic device. The updated “time recording” data “2 days” is then forwarded to the NFC tag. Next, the NFC tag forwards the updated “time recording” data to the data management system that may be finally updated to the data management system.

In the “time recording” example described in the previous paragraph, the employee retrieves “time recording” data from the employee data management system and updates the “time recording” data to the employee data management system, using the NFC tag, without logging to the employee network or the employee data management system. The NFC tag therefore allows a user to conveniently access and update application data without requiring the user to login to the data management system.

The programmed NFC tag 104, including the “data transfer” program, can be used by any number of applications that require one-way or two-way communication between the portable electronic device 102 and the data management system 110 to transfer application data. For example, the programmed NFC tag 104 may be used by a “leave request” application that requires a one-way communication to push a leave request, from the portable electronic device 102, to the data management system 110, without a user logging to the data management system 110.

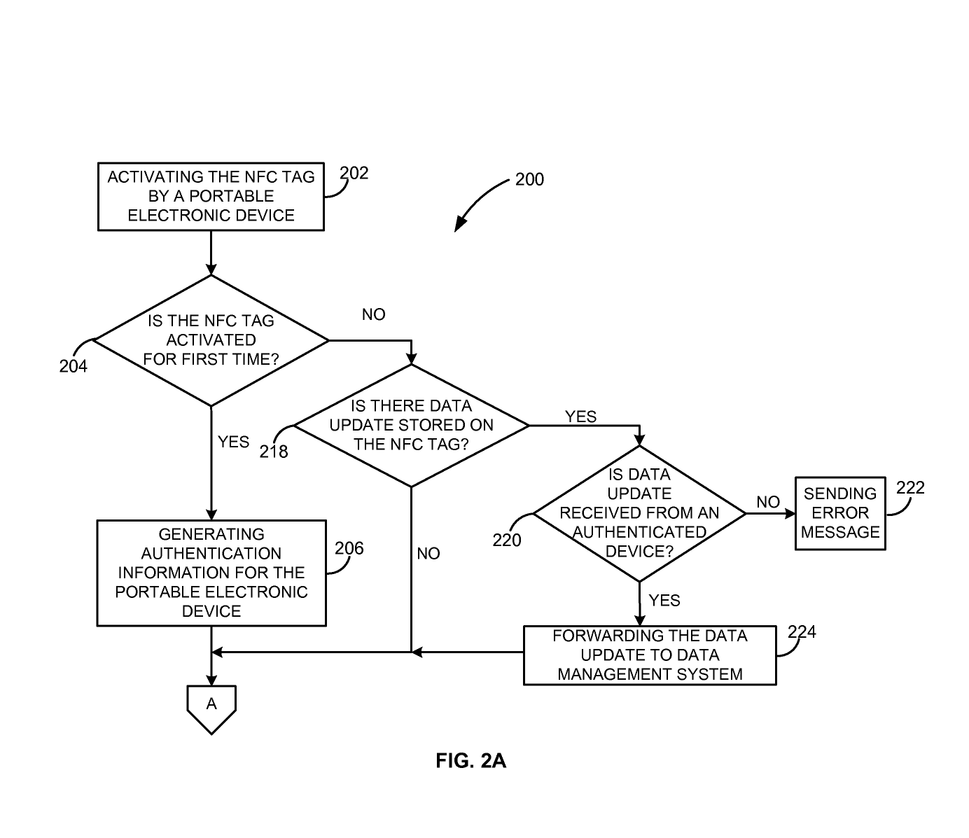

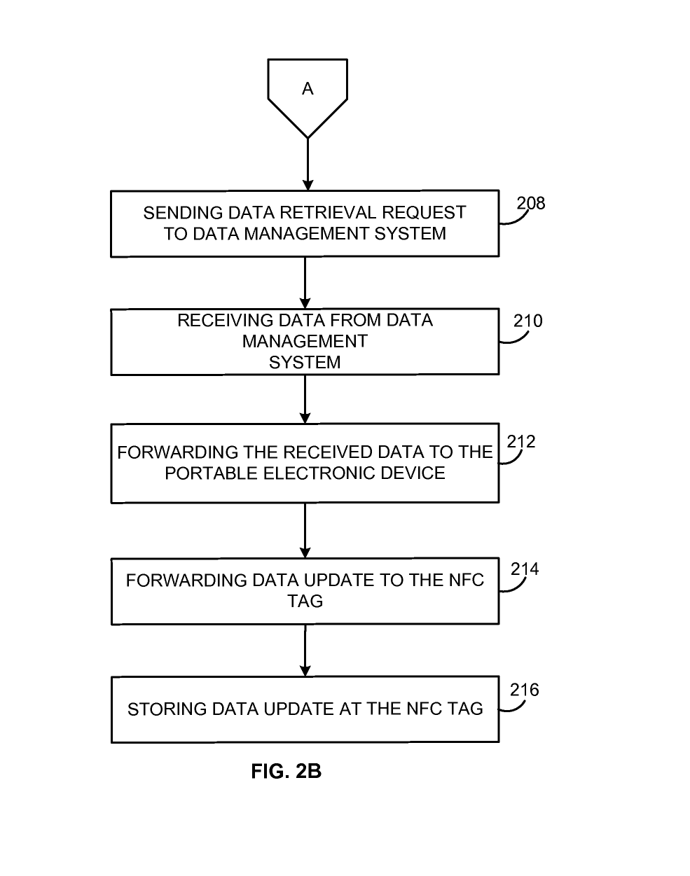

FIGS. 2A-2B are flow diagrams illustrating an algorithm for “data transfer” process 200 written to an NFC tag, according to an embodiment. The “data transfer” process 200 may define data transfer steps for transferring data between two devices, for example, a portable electronic device and a data management system. In one embodiment, the “data transfer” method may be included in a “data transfer” program that is written to a “data transfer” IC included in the NFC tag. After the write operation, the steps included in the “data transfer” method may be used to transfer application data, of an application, between the portable electronic device and the data management system.

In one embodiment the “data transfer” process 200 includes initially, at 202 (FIG. 2A), activating the NFC tag by a portable electronic device. NFC tag, or a smart tag, may be a passive device that is capable of NFC communication. A passive device is a device that does not require a source of energy for its operation. The NFC tag may be activated based on the magnetic field induced by a NFC enabled portable electronic device that is in contact or proximity of the NFC tag. The NFC tag may be activated by a NFC enabled portable electronic device.

Next, a check is performed to determine whether the NFC tag is being activated for first time (at 204). The NFC tag may be activated for the first time when the NFC enabled portable electronic device is in contact or in proximity of the NFC tag, for the first time. In case the NFC tag is activated for the first time, authentication information is generated for the portable electronic device of the user, at 206. During the authentication information generation operation, a unique identification key may be generated and linked to user identification information related to the user of the portable electronic device.

Next, at 208 (FIG. 2B), after the generation of authentication information, the NFC tag may send a data retrieval request to the data management system. The data retrieval request may be sent to retrieve data from the data management system. Based on the data retrieval request, the NFC tag may receive data from the data management system (at 210). In one embodiment, the data received by the NFC tag is dynamic data. Dynamic data denotes data that is asynchronously changed as further updates to the data become available. For example, “number of hours spent” on a project, by a user, is a dynamic data that changes based on the time spent by the user working on the project. In one embodiment, the NFC tag is programmed to receive and send dynamic data.

Next, at 212, the NFC tag may forward the dynamic data received from the data management system to the portable electronic device. In one embodiment, data update may be received at the portable electronic device. A user of the portable electronic device may want to update the dynamic data received from the NFC tag. In this case, the user may provide the data update at the portable electronic device. The data update may be an updated version of the dynamic data received from the data management system. In one embodiment, the data update is the most recent version of the dynamic data that the user wants to upload to the data management system. For example, consider that the data received from the employee data management system is user's leave data that includes the number of leaves the user has applied for in a particular year. In case the leave data is incorrect, then the user may provide, at the portable electronic device, a leave data update with the correct number of leaves that the user wants to update to the data management system. The data update received at the portable electronic device may then be forwarded at 214, to an NFC tag that stores (218) the data update received from the portable electronic device. The data update may be stored in the “data transfer” IC included in the NFC tag.

When the NFC tag is activated and it is determined that the NFC tag has been activated before, a check is performed at 218 (FIG. 2A) to identify whether any data update for the dynamic data is stored on the NFC tag. In case, a data update is stored on the NFC tag, then a data authentication check may be performed at 220 to determine whether the data update is being received from an authenticated portable electronic device. The check at 220 may be performed based on the authentication information generated for the portable electronic device at 206. In case the device is an un-authenticated portable electronic device, an error message may be sent, at 222, to the user of the portable electronic device. In case the data update is received from an authenticated portable electronic device the data update stored on the NFC tag is forwarded to the data management system (224).

After the “data transfer” program including the “data transfer” process is written to the NFC tag, an application may use the “data transfer” process 200 to transfer data between the portable electronic device and the data management system. In one embodiment, some applications may use a portion of the data transfer steps included in the “data transfer” process 200 for transferring application data. For example, consider a “hotel booking” application on the portable electronic device. A user may provide details of the hotel booking that may be sent to the NFC tag. The NFC tag may store the hotel booking information received from the user. On the next NFC tag activation, the hotel booking information of the user may be transferred to the data management system. In this case, the “hotel booking” application only used the steps 218-224 of the “data transfer” program for transferring application data.

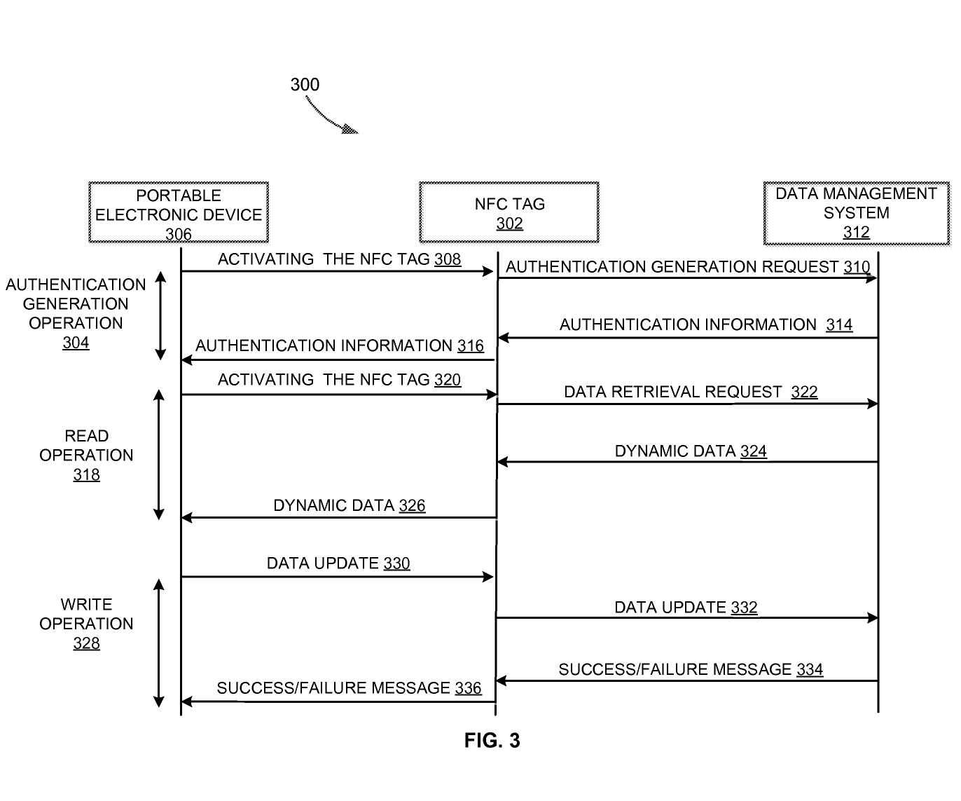

FIG. 3 is a sequence diagram 300 illustrating a method for transferring data by a NFC tag 302, according to an embodiment. The data may be application data related to an application. The application data may be transferred based on “data transfer” program written to NFC tag 302. In one embodiment, the data transfer operation for the application may be performed by executing the “data transfer” program written to the NFC tag 302. For performing the data transfer operation, authentication generation operation 304 is initially performed to generate authentication information for the portable electronic device 306 of a user. In one embodiment, the authentication generation operation 304 is performed, when the NFC tag is activated 308 for the first time. When the NFC tag 302 is activated 308 by portable electronic device 306 for the first time, then an authentication generation request may be sent 310 to data management system 312. In response, the data management system 312 may generate authentication information for the portable electronic device 306. The data management system 312 forwards 314 the generated authentication information to the NFC tag 302. In one embodiment, the authentication information may include a unique identification, generated by the data management system 312, for the portable electronic device 306. The NFC tag 302 may then forward 316 the authentication information to the portable electronic device 306. The generated authentication information may then be used for authenticating the portable electronic device 306, during any subsequent activation of the NFC tag 302 by the portable electronic device 306.

For example, consider a new employee of company ABC is activating an NFC tag for the first time. After the activation, the NFC tag may send an authentication generation request to the data management system of company ABC. The data management system of company ABC may in response send authentication information corresponding to the portable electronic device of the employee that may be used for identifying the portable electronic device, whenever the portable electronic device of the employee activates the NFC tag.

Next, after the authentication generation operation 304, the “data transfer” program written to the NFC tag may be used to perform a read operation 318 to read static and/or dynamic data from the data management system 312. The dynamic data may be application data related to a particular application. In one embodiment, the application may be stored on the portable electronic device 306. An application or an “app” is computer software that performs useful tasks. In one embodiment, the application may use the “data transfer” program written to the NFC tag for performing the useful task. For reading the dynamic data, the NFC tag 302 may initially be activated 320. The activated NFC tag 302 may then send 322 data retrieval request to the data management system 312. The data retrieval request may be sent for retrieving data related to a particular application. Based on the received request, the data management system 312 may send 324 the requested data to the NFC tag 302. The NFC tag 302 may then forward 326 the received data, e.g., related to a particular application, to the portable electronic device 306. For example, assume that a “user profile” application is stored at the portable electronic device. For reading application data related to the “user profile” application, the NFC tag may send a data retrieval request to receive the dynamic “user profile” data, including the user's name, the user's current “cost center”, the user's manager name, from a user data management system. A user name “ABCD”, user's cost center “1001”, and user's manager name “XYZ” retrieved from the data management system may be received as dynamic “user profile” data at the NFC tag. The NFC tag may then forward the dynamic “user profile” data to the portable electronic device.

In one embodiment, the “data transfer” program written to the NFC tag 302 may also be used to perform write operation 328 for writing data update related to an application to the data management system 312. For the write operation 328, the NFC tag 302 may receive 330 data update from the portable electronic device 306. The data update may be received in response to the dynamic data received at the portable electronic device 306, during the read operation 318. The data update may be triggered by a user of the portable electronic device 306. The user may input the data update at the portable electronic device 306 which may forward 330 the data update to the NFC tag 302. In one embodiment, the data update received from the portable electronic device 306 may be stored in the NFC tag 302. The data update may be stored in the “data transfer” IC included in the NFC tag. Next, when the NFC tag 302 is activated, the data update stored in the NFC tag 302 may be forwarded 332 to the data management system 312. In response, the data management system 312 may send 334 a success or failure message depending on the success or failure in writing the data update to the data management system 312. Finally, the success/failure message is sent 336 to the portable electronic device 306.

In the “user profile” application example, the user may provide a data update to correct the “cost center” information stored in the data management system. The received “cost center” information “1111” may then be stored on the NFC tag. The correct “cost center” information “1111” stored on the NFC tag may be forwarded and stored at the data management system, for updating the “cost center” information at the data management system. The NFC tag therefore allows the two way data communication between the data management system and the portable electronic device without requiring the user to login to the data management system.

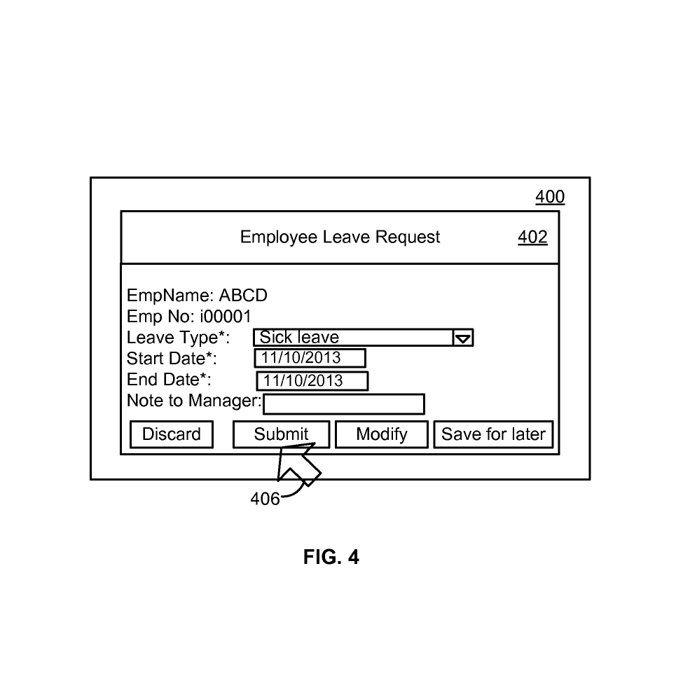

FIG. 4 is an exemplary user interface 400 of a portable electronic device displaying a graphical user interface of employee leave request application 402, according to an embodiment. The employee leave request application 402 allows an employee to apply for leave request using the portable electronic device. In case an employee wants to apply for a leave request, the employee may choose the type of leave (sick leave, privilege leave, optional leave, etc.), the start date and end date of the leave, and a note to the manager. When the employee selects the “Submit” button 406, the leave request data that includes leave type, start and end date, and note to the manager, received at the employee leave request application 402 is forwarded to a NFC tag that stores the leave request data. Based on the “data transfer” program, when the NFC tag storing the leave request data is activated, the stored leave request data is transferred to an employee data management system. The employee data management system may be a data server storing employee information. The employee data management system may then send a success message to the NFC tag when the leave request data is successfully written to the data management system, or a failure message when the leave request is not successfully written to the employee data management system. The NFC tag may forward the success or failure message to the portable electronic device of the user.

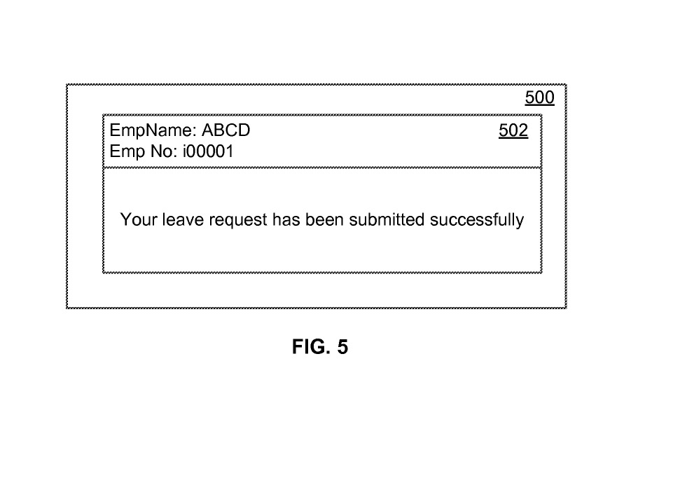

FIG. 5 is an exemplary user interface 500 of a portable electronic device displaying a success message 502, according to an embodiment. The success message 502 is forwarded by the NFC tag to the portable electronic device, after the NFC tag receives the success message from the employee data management system. The success message 502 indicates that the leave request has been successfully updated to the employee data management system. The NFC tag therefore allows the employee to successfully update the leave request data to the data management system without requiring the user to login to the data management system.

Some embodiments may include the above-described methods being written as one or more software components. These components, and the functionality associated may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

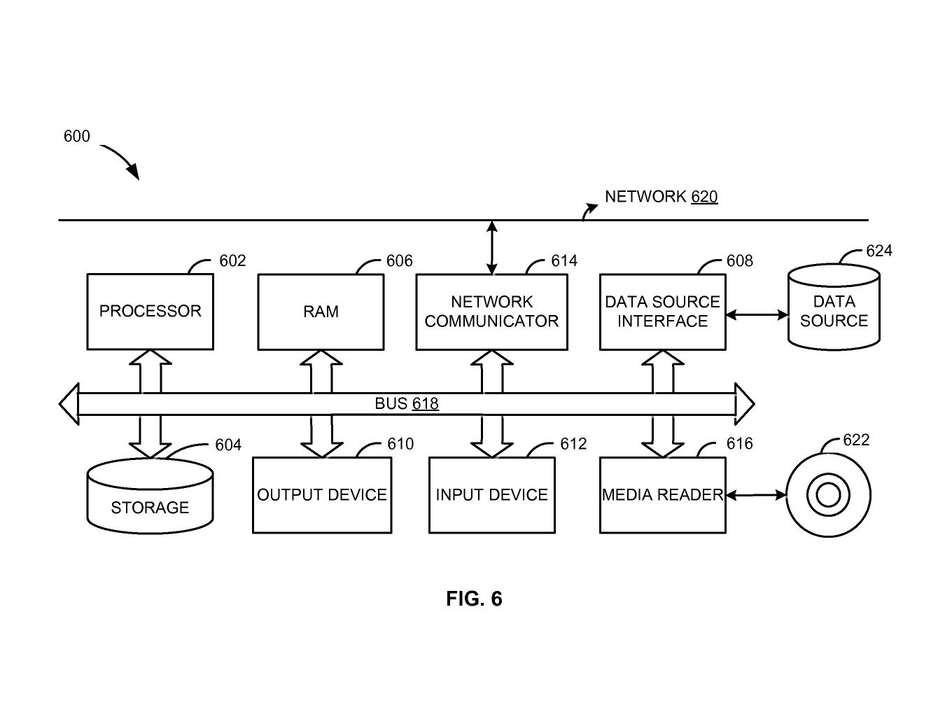

FIG. 6 is a block diagram of an exemplary computer system 600. The computer system 600 includes a processor 602 that executes software instructions or code stored on a computer readable storage medium 622 to perform the above-illustrated methods. The processor 602 can include a plurality of cores. The computer system 600 includes a media reader 616 to read the instructions from the computer readable storage medium 622 and store the instructions in storage 1004 or in random access memory (RAM) 606. The storage 604 provides a large space for keeping static data where at least some instructions could be stored for later execution. According to some embodiments, such as some in-memory computing system embodiments, the RAM 606 can have sufficient storage capacity to store much of the data required for processing in the RAM 606 instead of in the storage 604. In some embodiments, the data required for processing may be stored in the RAM 606. The stored instructions may be further compiled to generate other representations of the instructions and dynamically stored in the RAM 606. The processor 602 reads instructions from the RAM 606 and performs actions as instructed. According to one embodiment, the computer system 600 further includes an output device 610 (e.g., a display) to provide at least some of the results of the execution as output including, but not limited to, visual information to users and an input device 612 to provide a user or another device with means for entering data and/or otherwise interact with the computer system 600. Such output devices 610 and input devices 612 could be joined by one or more additional peripherals to further expand the capabilities of the computer system 600. A network communicator 614 may be provided to connect the computer system 600 to a network 620 and in turn to other devices connected to the network 650 including other clients, servers, data stores, and interfaces, for instance. The modules of the computer system 600 are interconnected via a bus 618. Computer system 600 includes a data source interface 608 to access data source 624. The data source 624 can be accessed via one or more abstraction layers implemented in hardware or software. For example, the data source 624 may be accessed by network 620. In some embodiments the data source 624 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the invention are described herein for illustrative purposes, various equivalent modifications are possible within the scope of the invention, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method for near field communication (NFC) based data transfer, the method comprising:
a NFC tag, receiving dynamic data from a data management system;
the NFC tag, forwarding the received dynamic data to a portable electronic device;
based on the forwarded dynamic data, the NFC tag receiving data update from the portable electronic device; and
forwarding, by the NFC tag, received data update to the data management system.

2. The computer implemented method according to claim 1, further comprising:
the portable electronic device, activating the NFC tag;
receiving, at the portable electronic device, the dynamic data for an application stored at the portable electronic device;
at the portable electronic device, displaying the received dynamic data;
based on the displayed dynamic data, receiving, at the portable electronic device, the data update; and
the portable electronic device, forwarding the data update to the NFC tag.

3. The computer implemented method according to claim 1, further comprising:
storing the received data update to the NFC tag.

4. The computer implemented method according to claim 3, further comprising:
based on activating the NFC tag, detecting the stored data update at the portable electronic device; and
forwarding the stored data update to the data management system.

5. The computer implemented method according to claim 4, further comprising:
the NFC tag, authenticating the portable electronic device; and
based on the authentication, the NFC tag forwarding the stored data update to the data management system.

6. The computer implemented method according to claim 1, further comprising:
the NFC tag, sending a data retrieval request to the data management system; and
based on the data retrieval request, the NFC tag receiving the dynamic data from the data management system.

7. The computer implemented method according to claim 1, further comprising:
programming, by a processor of a computer, the NFC tag to transfer data between the portable electronic device and the data management system.

8. A computer system for near field communication (NFC) based data transfer, the computer system comprising:
a processor to execute a program code; and
a memory coupled to the processor, the memory storing the program code comprising:
receive, by a NFC tag, dynamic data from a data management system;
forward, by the NFC tag, the received dynamic data to a portable electronic device;
based on the forwarded dynamic data, receive, by the NFC tag, data update from the portable electronic device; and
forward received data update to the data management system.

9. The computer system according to claim 8, further comprising:
activate the NFC tag by the portable electronic device;
receive, at the portable electronic device, the dynamic data for an application stored at the portable electronic device;
display the received dynamic data at the portable electronic device;
based on the displayed dynamic data, receive, at the portable electronic device, the data update; and
forward, by the portable electronic device, the data update to the NFC tag.

10. The computer system according to claim 8, further comprising:
store the received data update to the NFC tag; and
forward the stored data update to the data management system.

11. The computer system according to claim 10, further comprising:
based on activating the NFC tag, detect the stored data update at the portable electronic device; and
forward the stored data update to the data management system.

12. The computer system according to claim 11, further comprising:
authenticate the portable electronic device; and
based on the authentication, forward the stored data update to the data management system.

13. The computer system according to claim 8, further comprising:
send a data retrieval request, by the NFC tag, to the data management system; and
based on the data retrieval request, the NFC tag receive the dynamic data from the data management system.

14. An article of manufacture including a non-transitory computer readable storage medium to tangibly store instructions, which when executed by a computer, cause the computer to:
receive, by a near field communication (NFC) tag, dynamic data from a data management system;
forward, by the NFC tag, the received dynamic data to a portable electronic device;
based on the forwarded dynamic data, receive, by the NFC tag, data update from the portable electronic device; and
forward received data update to the data management system.

15. The article of manufacture according to claim 14, further comprising instructions which when executed by the computer further causes the computer to:
activate the NFC tag by the portable electronic device;
receive, at the portable electronic device, the dynamic data for an application stored at the portable electronic device;
display the received dynamic data at the portable electronic device;
based on the displayed dynamic data, receive, at the portable electronic device, the data update; and
forward, by the portable electronic device, the data update to the NFC tag.

16. The article of manufacture according to claim 14, further comprising instructions which when executed by the computer further causes the computer to:
store the received data update to the NFC tag; and
forward the stored data update to the data management system.

17. The article of manufacture according to claim 16, further comprising instructions which when executed by the computer further causes the computer to:
based on activating the NFC tag, detect the stored data update at the portable electronic device; and
forward the stored data update to the data management system.

18. The article of manufacture according to claim 17, further comprising instructions which when executed by the computer further causes the computer to:
authenticate the portable electronic device; and
based on the authentication, forward the stored data update to the data management system.

19. The article of manufacture according to claim 14, further comprising instructions which when executed by the computer further causes the computer to:
send a data retrieval request, by the NFC tag, to the data management system; and
based on the data retrieval request, receive the dynamic data from the data management system.

20. The article of manufacture according to claim 14, further comprising instructions which when executed by the computer further causes the computer to:
forward authentication information generated by the data management system to the portable electronic device.

21. An article of manufacture including a non-transitory computer readable storage medium to tangibly store instructions, which when executed by a computer, cause the computer to:
activate a near field communication (NFC) tag by a portable electronic device;
send a data retrieval request, by the activated NFC tag, to retrieve dynamic data from a data management system;
based on the data retrieval request, receive the dynamic data from the data management system;
forward, by the NFC tag, the received dynamic data to the portable electronic device;
based on the forwarded dynamic data, receive, by the NFC tag, data update from the portable electronic device;
store the received data update to the NFC tag; and
forward the received data update to the data management system.
